(19) United States
(12) Patent Application Publication
(10) Pub. No.: US 2010/0232138 A1
(43) Pub. Date: Sep. 16, 2010

(54) Light Guide Plate Having Sectional Light Guiding Structure

(76) Inventor: Chung-Lin Tsai, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 12/581,864

(22) Filed: Oct. 19, 2009

(30) Foreign Application Priority Data
Mar. 13, 2009 (TW) 098115821

(51) Int. Cl. G02F 1/13357

(52) U.S. Cl. 362/97.1

(57) ABSTRACT

A light guide plate (LGP) having a sectional light guiding structure is provided. The LGP is integrally configured with first grooves extending from a first side of the LGP to a second side of the LGP, and second grooves extending from a third side of the LGP to a fourth side of the LGP. The first grooves intersect with the second grooves, thus dividing the first surface of the LGP into a plurality of light guiding sections. Light sources are disposed in the first grooves and/or the second grooves. A sequence of lighting the light sources is controlled for respectively controlling the light sources to project light into the light guiding sections, so that the light guiding sections are controlled to guide the light according to a predetermined sequence.

### BACKGROUND OF THE INVENTION

1. Field of the Invention

The present invention relates generally to a light guide plate (LGP) of a backlight module.

2. The Prior Arts

Typically, a backlight module of a liquid crystal display (LCD) includes a LGP. A reflective sheet is provided at a first surface of the LGP, and a plurality of optical sheets including at least a diffusion sheet and a prism sheet are provided at a second surface of the LGP opposite to the first surface. All of these components are then framed in an outer frame. A light source is provided at a lateral side of the LGP for projecting a light inside the LGP. A part of the light is reflected by the reflective sheet to sequentially pass through the diffusion sheet and the prism sheet for outputting.

Generally, the LGP is usually configured with a consecutive configuration, so that the light is continuously transmitted in the LGP. In other words, the LGP as a whole presents a relatively uniform light output. When such an LGP is employed in an LCD panel. An image displayed on the LCD panel is often presented with approximately uniform luminance.

However, an individual image displayed on the LCD panel is not always intrinsically desired to be displayed with approximate luminance. For example, a scenario of a white building standing in the darkness requires for a sharp contrast. Therefore, for achieving sharper and more vivid displaying performance, a conventional backlight module including discrete light guiding sections has been proposed. Each of the discrete light guiding sections is adapted for guiding a light individually provided thereto. As such, each light guiding section of the LGP is provided with a light source at a lateral side thereof. An electronic circuit is employed for controlling the sequence of lighting the light sources of the light guiding sections of the LGP in correspondence with the images displayed on the LCD. In such a way, an image displayed on the LCD can be displayed with a sharp contrast, in that where should be dark can be displayed darker, and where should be bright can be displayed brighter.

The conventional backlight module including discrete light guiding sections is fabricated by jointing a plurality of small size LGPs together. The joints between the small size LGPs cannot guide light therethrough. In such a way, the light provided by the light source of each light guiding section can be transmitted in the light guiding section only.

However, the foregoing process of fabricating the conventional backlight module including discrete light guiding sections is complicated and expensive. Accordingly, Applicant has previously proposed a solution which can be learnt by referring to Taiwanese Patent No. M320073.

### SUMMARY OF THE INVENTION

Taiwanese Patent No. M320073 provided an LGP including a plurality of discrete light guiding sections. The LGP is featured in that a plurality of light guiding sections are configured by forming a plurality of grooves at the LGP. A primary objective of the present invention is to provide a light source distribution incorporating the LGP structure as disclosed in Taiwanese Patent No. M320073, so as to achieve a better displaying performance.

The present invention provides an LGP having a sectional light guiding structure. The LGP includes a first surface and a second surface opposite to the first surface. The LGP is integrally configured with first grooves extending from a first side of the LGP to a second side of the LGP. The first side is opposite to the second side. According to an aspect of the embodiment, the LGP may be further integrally configured with second grooves extending from a third side of the LGP to a fourth side of the LGP. The third side is opposite to the third side. The first grooves intersect with the second grooves, thus dividing the first surface of the LGP into a plurality of light guiding sections. Light sources are disposed in the first grooves and/or the second grooves. A sequence of lighting the light sources is controlled for respectively controlling the light sources to project light into the light guiding sections, so that the light guiding sections are controlled to guide the light according to a predetermined sequence.

According to an embodiment of the invention, the light sources can be disposed at one side of the first grooves and/or the second grooves, or alternatively the light sources can be disposed at two opposite sides of the first grooves and/or the second grooves, so as to project the light from one side or two sides of the first grooves and/or the second grooves into the LGP.

According to another embodiment of the invention, a cross-sectional view of the first grooves or the second grooves is a geometrical configuration (e.g., trapezoid or horseshoe-shape) having at least one sidewall being a vertical plane which serves as a light input surface from which the light is projected inside the LGP.

According to a further embodiment of the invention, an optical structure is provided at the first grooves and/or the second grooves for improving the optical uniformity at the joints.

The present invention provides the light sources inside grooves of the LGP, so that the path of the light projection can be shortened, and the light sources are avoided from exposure. As such, the backlight module can be made smaller, and is thus more suitable for thin and portable electronic products.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a light guide plate (LGP) according to an embodiment of the present invention;

FIG. 2 is a top view of the LGP as illustrated in FIG. 1, in which light sources are provided at one inner side of respective first groove and a lateral side of the LGP according to an embodiment of the present invention;

FIG. 2A is a cross-sectional view of FIG. 2 along line IIA-IIA;

FIG. 2B is a top view of the LGP as illustrated in FIG. 1, in which light sources are provided at one inner side of respective first groove and two opposite inner sides of the leftmost first groove according to an embodiment of the present invention;

FIG. 3 is a top view of the LGP as illustrated in FIG. 1, in which light sources are provided at two opposite inner sides of respective first groove and a lateral side of the LGP according to an embodiment of the present invention;

FIG. 3A is a cross-sectional view of FIG. 3 along line IIIA-IIIA;

FIG. 4 is a cross-sectional view of the LGP illustrating a horseshoe-shaped cross-section of the first grooves, and a light source provided at one inner side of respective first groove;

FIG. 4A is a cross-sectional view of the LGP illustrating a horseshoe-shaped cross-section of the first grooves, and a light source provided at two opposite inner sides of respective first groove;

FIG. 5 is a perspective view of an LGP configured with intersected first grooves and second grooves, according to an embodiment of the present invention;

FIG. 5A is a top view of the LGP as illustrated in FIG. 5, in which light sources are provided at one inner side of respective first groove and a lateral side of the LGP according to an embodiment of the present invention;

FIG. 5B is a top view of the LGP as illustrated in FIG. 5, in which light sources are provided at one inner side of respective first groove and two opposite inner sides of the leftmost first groove according to an embodiment of the present invention;

FIG. 6 is a perspective view of an LGP configured with intersected first grooves and second grooves, according to an embodiment of the present invention;

FIG. 6A is a top view of the LGP of FIG. 6, in which light sources are provided at two opposite inner sides of respective first groove, according to an embodiment of the present invention; and

FIG. 6B is a top view of the LGP of FIG. 6, in which light sources are provided at two opposite inner sides of respective first groove and two opposite sides of respective second groove, according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

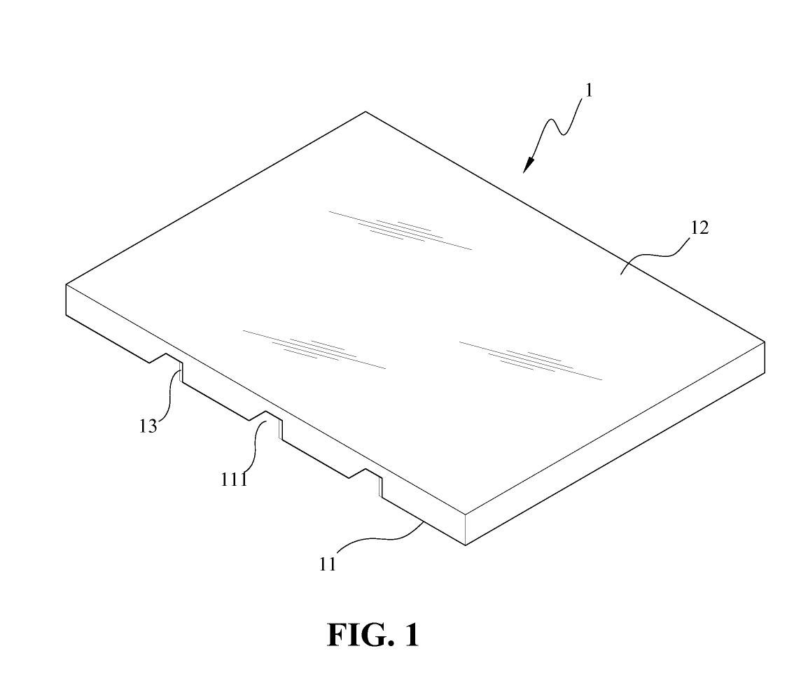

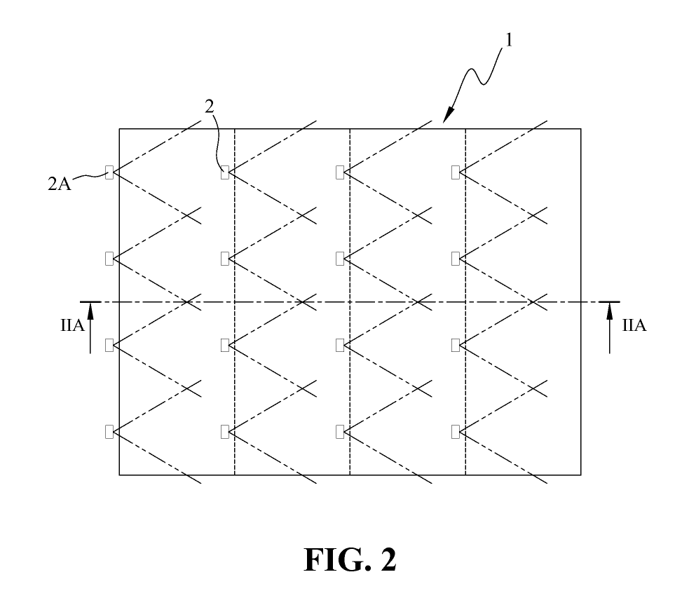

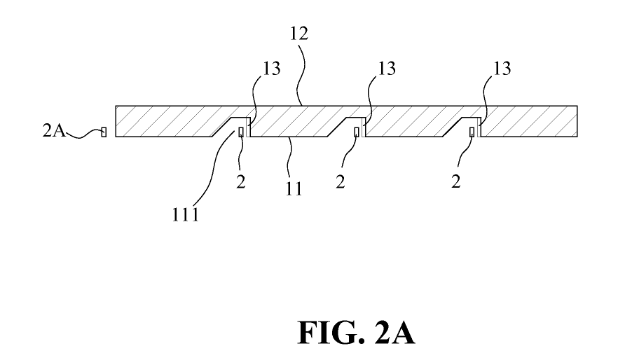

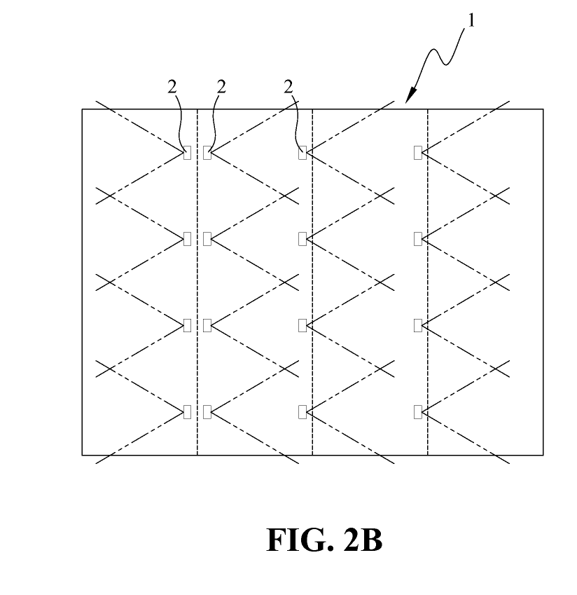

FIG. 1 is a perspective view of a light guide plate (LGP) according to an embodiment of the present invention. FIG. 2 is a top view of the LGP as illustrated in FIG. 1, in which a plurality of light sources 2 are provided at one inner side of respective first groove and a lateral side of the LGP according to an embodiment of the present invention. FIG. 2A is a cross-sectional view of FIG. 2 along line IIA-IIA. Referring to FIGS. 1 through 2A, a light guide plate (LGP) 1 is illustrated. The LGP 1 includes a first surface 11 and a second surface 12 opposite to each other. The LGP 1 includes a plurality of first grooves 111 integrally configured with the LGP 1. The first grooves 111 extend from a first side of the LGP 1 to a second side of the LGP 1. The first side is positioned opposite to the second side. The first grooves 111 divide the first surface into a plurality of light guiding sections. According to an aspect of the embodiment, the first grooves 111 are formed together with the LGP 1 by an injection molding process. Alternatively, the first grooves 111 can also be formed by a secondary processing conducted to a plate preform of the LGP 1.

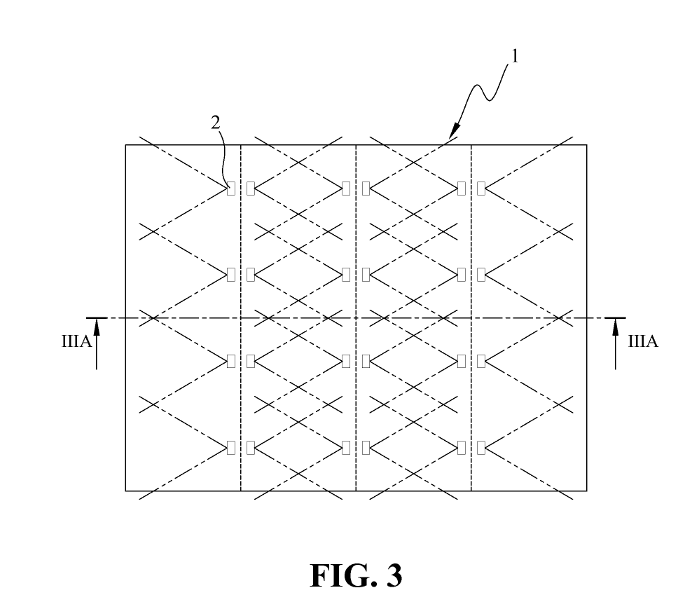

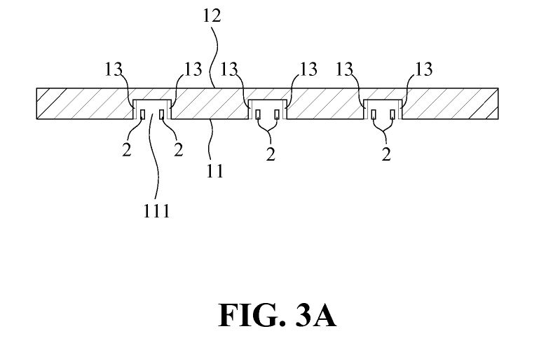

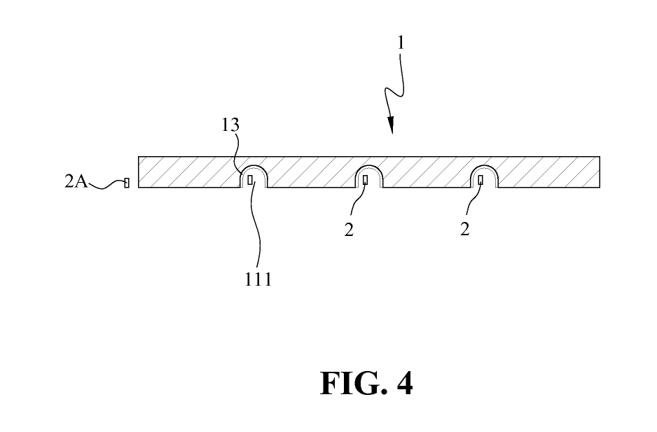

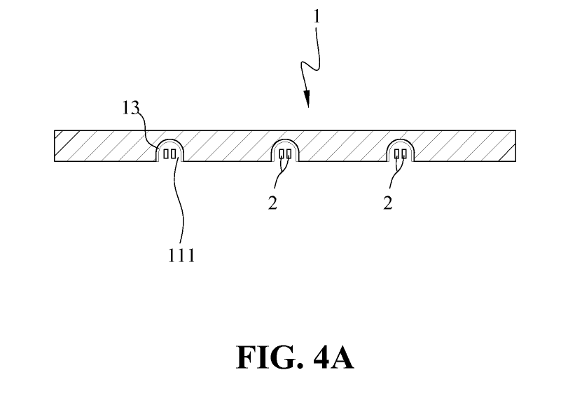

According to the embodiment of the present invention, the first grooves are parallel with each other, thus dividing the first surface 11 into a plurality of rectangular-shaped light guiding sections. The cross-section of the first grooves 111 can be a trapezoid having a vertical sidewall as shown in FIG. 2A. Or otherwise, the cross-section of the first grooves 111 can be a horseshoe-shape having two vertical sidewalls as shown in FIG. 4. The vertical sidewalls serve as light input surfaces, from which the light sources 2 are allowed to project the light into the LGP 1. Further, in order to make the light passing through the LGP 1 softer, an optical structure 13 can be provided at a surface of the first grooves 111. For example, a plurality of fine dots are distributed onto the surface of the first grooves 111 by conducting a sandblasting process, a printing process or a non-printing process. The fine dots are adapted for reflecting and refracting light illuminating thereon, so as to eliminate the dark lines occurred at the first grooves 111 and the non-uniform lighting performance thereby. As shown in FIG. 2A, the light sources 2 are respectively provided at one inner side of respective first groove 111 for projecting the light from the vertical sidewalls of the first grooves 111 into the LGP 1. When the light sources 2 are provided at only one side of respective first groove 111, as shown in FIG. 2, there is one light guiding section, i.e., the leftmost light guiding section hereby, having no corresponding first grove 111 accommodating light sources 2 to project light thereto. As such, additional light sources 2A must be provided at a lateral side of the LGP 1 for projecting the light into the leftmost light guiding section. In such a way, all of the light guiding sections can be provided with the light by the light sources 2. Alternatively, as shown in FIG. 2B, the light sources 2 are provided at two opposite inner sides of the leftmost first groove 111, while only one side of the other first grooves 111 is provided with the light sources 2. As a further alternative embodiment, as shown in FIGS. 3 and 3A, the light sources 2 can also be provided at two opposite inner sides of each of the first grooves 111, so that each of the light guiding sections can be provided with the light from two opposite sides thereof. A sequence of lighting the light sources 2 is controlled, so as to control each of the light guiding sections to guide light in accordance with a predetermined sequence, thus improving the illumination performance of the image details. It should be noted that when the light sources 2 are provided at two opposite inner sides of each of the first grooves 111, the two opposite inner side must present as two vertical sidewalls. In other words, the cross-section of the first grooves 111 is a reverse U-shape for allowing the light to be properly projected into the light guiding sections from both sides thereof.

FIG. 4 is a cross-sectional view of the LGP illustrating a horseshoe-shaped cross-section of the first grooves, and a light source provided at one inner side of respective first groove. FIG. 4A is a cross-sectional view of the LGP illustrating a horseshoe-shaped cross-section of the first grooves, and a light source provided at two opposite inner sides of respective first groove. Referring to FIGS. 4 and 4A, since both of the inner sidewalls of respective first groove 111 are vertical sidewalls, the light sources 2 can be provided at one inner side as shown in FIG. 4, or both of the two opposite inner sides of the first groove 111 as shown in FIG. 4A.

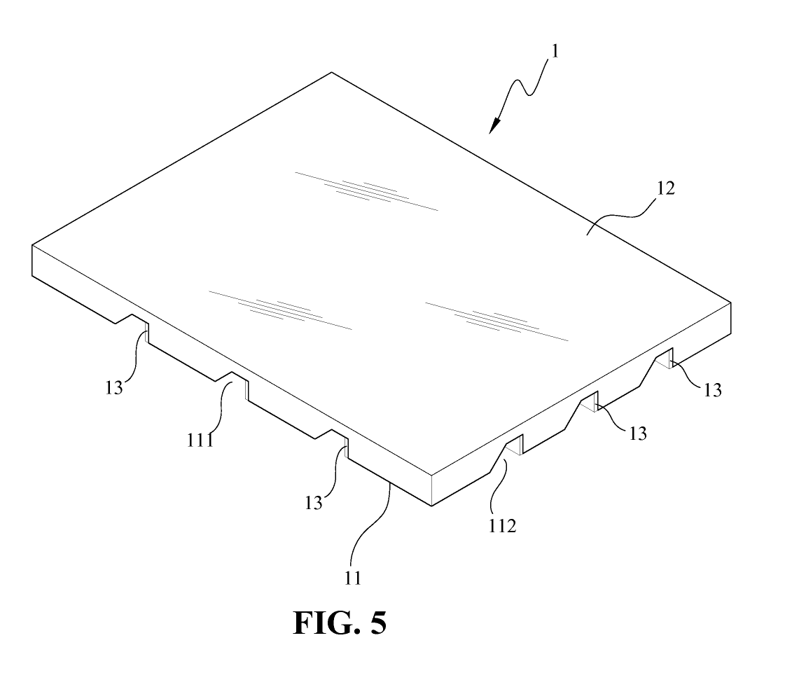

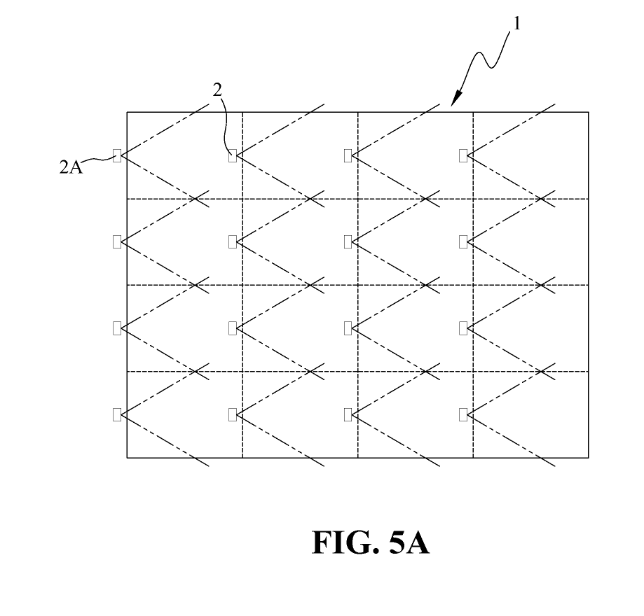

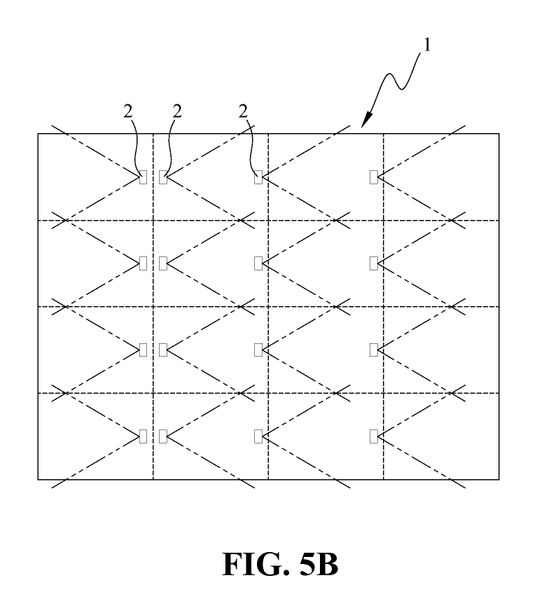

FIG. 5 is a perspective view of an LGP configured with intersected first grooves and second grooves, according to an embodiment of the present invention. Referring to FIG. 5, in addition to the first grooves 111, the LGP 1 further includes a plurality of second grooves 112 extending from a third side of the LGP 1 to a fourth side of the LGP 1. The third side is positioned opposite to the fourth side. The second grooves 112 are intersected with the first grooves 111. Preferably, similar to the first grooves 111, the second grooves 112 are also parallel with each other. As such, the first grooves 111 and the second grooves 112 intersect the first surface of the LGP 1 into a plurality of rectangular-shaped light guiding sections. The cross-sectional configuration of the second grooves 112 can be same with or different from that of the first grooves 111. When the LGP 1 includes the first grooves 111 and the second grooves 112, the light sources 2 can be provided in the first grooves 111 or the second grooves 112, or provided in both of the first grooves 111 and the second grooves 112. Further, the light sources 2 provided in the first and/or second grooves 111 and 112 can be provided at only one inner side of respective first or second groove 111, 112, or provided at both of the two opposite inner sides of respective first or second groove 111, 112. In addition, it should be noted that the optical structure 13 as discussed above can also be optionally disposed on surfaces of the first grooves 111 and/or the second grooves 112.

FIG. 5A is a top view of the LGP as illustrated in FIG. 5, in which the light sources are provided at only one inner side of respective first groove and a lateral side of the LGP according to an embodiment of the present invention. FIG. 5B is a top view of the LGP as illustrated in FIG. 5, in which light sources are provided at one inner side of respective first groove and two opposite inner sides of the leftmost first groove according to an embodiment of the present invention. Referring to FIG. 5A, the light sources 2 are provided at only one inner side of respective first groove 111, and are not provided in the second grooves. Therefore the light projected from the light sources 2 can be projected from the vertical sidewalls of the first grooves 111 into the LGP 1. Similarly, as an alternative selection, the light sources 2 can also be provided at only one inner side of respective second groove 112, and are not provided in the first grooves 111 (not shown). When the light sources 2 are provided at only one side of respective first groove 111 or second groove 112, as shown in FIG. 5A, there is one light guiding section, i.e., the leftmost light guiding section hereby, having no corresponding first grove 111 or second groove 112 accommodating light sources 2 to project light thereto. As such, additional light sources 2A must be provided at a lateral side of the LGP 1 for projecting the light into the leftmost light guiding section. Alternatively, as shown in FIG. 5B, the light sources 2 are provided at two opposite inner sides of the leftmost first groove 111 or second groove 112, while only one side of the other first grooves 111 or second grooves 112 is provided with the light sources 2.

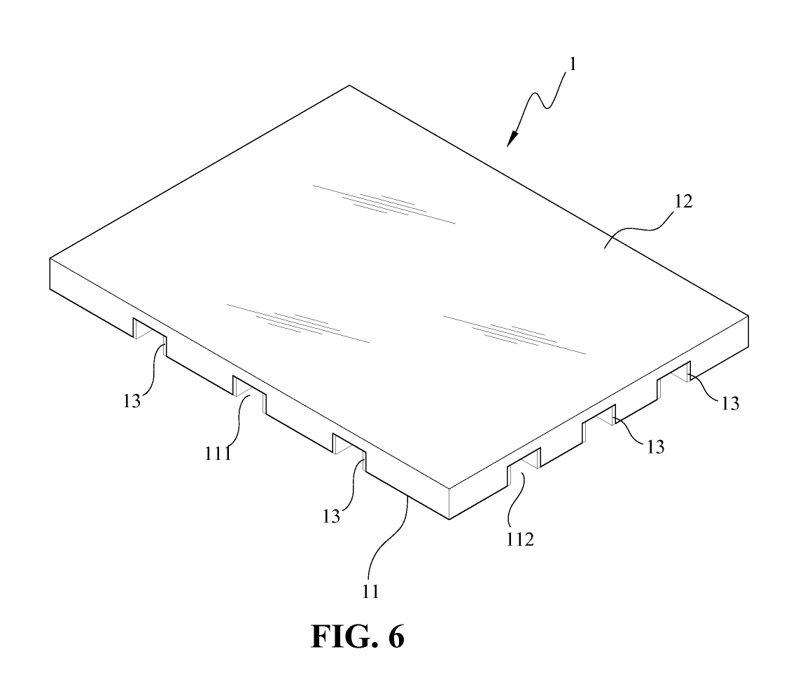

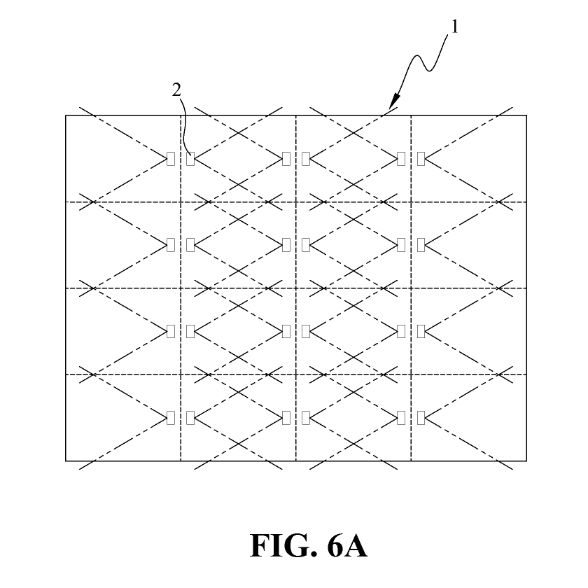

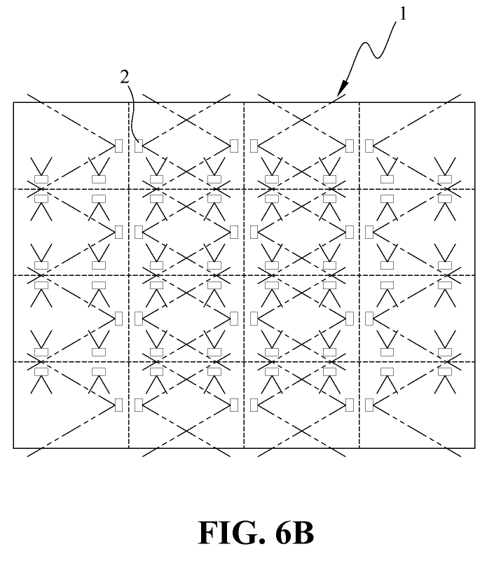

FIG. 6 is a perspective view of an LGP configured with intersected first grooves and second grooves, according to an embodiment of the present invention. As shown in FIG. 6, both of the first grooves 111 and the second grooves 112 have a reverse U-shaped cross-section. FIG. 6A is a top view of the LGP of FIG. 6, in which light sources are provided at two opposite inner sides of respective first groove, according to an embodiment of the present invention. FIG. 6B is a top view of the LGP of FIG. 6, in which light sources are provided at two opposite inner sides of respective first groove and two opposite sides of respective second groove, according to an embodiment of the present invention. Referring to FIG. 6A, the light sources 2 are provided at two opposite inner sides of respective first groove 111. As shown in FIG. 6B, the light sources 2 are provided at two opposite inner sides of respective first groove 111 and two opposite sides of respective second groove 112. A sequence of lighting the light sources 2 is controlled, so as to control each of the light guiding sections to guide the light in accordance with a predetermined sequence, thus improving the illumination performance of the image details.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light guide plate (LGP) having a sectional light guiding structure, wherein the LGP is a plate member having a first surface and a second surface opposite to the first surface, and the LGP is adapted for guiding a light transmitting therein, the LGP comprising:
at least one first groove configured at the first surface extending from a first side of the LGP to a second side of the LGP, wherein the first side and the second side are opposite to each other, and the at least one first groove divides the first surface of the LGP into a plurality of light guiding sections,
wherein a plurality of light sources are provided in the at least one first groove for projecting the light into the LGP.

2. The LGP according to claim 1, wherein the at least one first groove is plural, and the plurality of first grooves are parallel with each other.

3. The LGP according to claim 1, wherein the light sources are provided at one inner side of respective first groove.

4. The LGP according to claim 1, wherein the light sources are provided at two opposite inner sides of respective first groove.

5. The LGP according to claim 1, wherein the light sources are provided at one inner side of at least one of the first grooves, and two opposite inner sides of each of the rest first grooves.

6. The LGP according to claim 1, further comprising at least one second groove configured at the first surface extending from a third side of the LGP to a fourth side of the LGP, wherein the third side and the fourth side are opposite to each other, and the light guiding sections are divided from the first surface by the at least one first groove together with the at least one second groove.

7. The LGP according to claim 6, wherein the at least one second groove is plural, and the plurality of second grooves are parallel with each other.

8. The LGP according to claim 6, wherein the light sources are also provided inside respective second groove.

9. The LGP according to claim 8, wherein the light sources are provided at one inner side of respective second groove.

10. The LGP according to claim 8, wherein the light sources are provided at two opposite inner sides of respective first groove.

11. The LGP according to claim 8, wherein the light sources are provided at one inner side of at least one of the second grooves, and two opposite inner sides of each of the rest second grooves.

12. The LGP according to claim 1, wherein the at least one first groove has a trapezoid-shaped cross-section having at least one vertical sidewall.

13. The LGP according to claim 1, wherein the at least one first groove has a horseshoe-shaped cross-section.

14. The LGP according to claim 1, wherein the at least one first groove has a reverse U-shaped cross-section.

15. The LGP according to claim 1, wherein an optical structure is disposed on a surface of the at least one first groove.

16. The LGP according to claim 6, wherein the at least one second groove has a trapezoid-shaped cross-section having at least one vertical sidewall.

17. The LGP according to claim 6, wherein the at least one second groove has a horseshoe-shaped cross-section.

18. The LGP according to claim 6, wherein the at least one second groove has a reverse U-shaped cross-section.

19. The LGP according to claim 6, wherein an optical structure is disposed on a surface of each of the at least one first groove and the at least one second groove.
